(19) United States
(12) Patent Application Publication
(10) Pub. No.: US 2016/0277538 A1
(43) Pub. Date: Sep. 22, 2016

(54) METHOD AND SYSTEM FOR MATCHING PROFILE RECORDS

(71) Applicant: Conch&Media Ltd., Mississauga (CA)

(72) Inventors: Sam CHOW, Toronto (CA); Max KOSC, Mississauga (CA)

(21) Appl. No.: 15/070,203

(22) Filed: Mar. 15, 2016

Related U.S. Application Data
(60) Provisional application No. 62/134,101, filed on Mar. 17, 2015.

(51) Int. Cl. H04L 29/08

(52) U.S. Cl. CPC H04L 67/36; H04L 67/306

(57) ABSTRACT

According to embodiments described in the specification, an exemplary method and a system is provided for matching electronic data records. A server maintains, in memory, a plurality of user profile records, each record including an identifier, one or more subject trait parameters, and one or more desired trait parameters. The server receives a query including a user profile record identifier associated with a first electronic device, determines a mutual match by searching the plurality of user profile records using the query to locate a matched user profile record identifier associated with a second electronic device, populates, on a display of the first electronic device, reduced profile information corresponding to the matched user profile record identifier, receives, from the first electronic device, input including a rating of the reduced profile information, adjusts the reduced profile information according to the input, and updates the display with the adjusted, reduced profile information.

### FIELD OF TECHNOLOGY

The present disclosure relates to matching electronic data records. Certain embodiments provide a method and system for matching profile records in an online social network.

### BACKGROUND

Various techniques have been developed for matching electronic data records. Past approaches, including those for online dating applications or other online social networks, can suffer from several disadvantages, including that profile records corresponding to other users of interest are often tied to social graphs of personal relationships. Such approaches can limit the ability to discover other profile records of interest. Users wanting to locate others with specific characteristics, interests or tastes can find it limiting, cumbersome or inconvenient to use existing solutions that depend on particular social graphs or require searching through specific categories or places. Various matching techniques have been attempted but such techniques can be deficient where they depend on inferences about a user's preferences, in the case of recommender systems, or in being limited to keyword searches. Furthermore, privacy settings enforced by a social network provider can limit the ability to locate a match or to conveniently exchange profile information with a prospective match in a secure and private fashion.

Improvements in methods and systems for matching electronic data records are desirable, including those for matching profile records in an online social network.

The foregoing examples of the related art and limitations related thereto are intended to be illustrative and not exclusive. Other limitations of the related art will become apparent to those of skill in the art upon a reading of the specification and a review of the drawings.

### BRIEF DESCRIPTION OF THE DRAWINGS

Examples are illustrated with reference to the attached drawings. It is intended that the examples and figures disclosed herein be considered illustrative rather than restrictive.

FIG. 1 is a block diagram of a system for matching profile records in accordance with an example;

FIG. 2 is a block diagram of a social network provider in accordance with an example;

FIG. 3 is a flowchart illustrating a method for matching profile records in accordance with an example;

FIG. 4 through FIG. 6 are views illustrating example screenshots of an exemplary client application for use in accordance with the method of FIG. 3.

### DETAILED DESCRIPTION

The following describes a method in a server having a processor, a memory, and a network interface device including the steps of maintaining, in the memory, a plurality of user profile records, each user profile record including an identifier, one or more subject trait parameters, and one or more desired trait parameters, receiving a query including a user profile record identifier associated with a first electronic device, determining a mutual match by searching the plurality of user profile records using the query to locate a matched user profile record identifier associated with a second electronic device, populating, on a display of the first electronic device, reduced profile information corresponding to the matched user profile record identifier, receiving, from the first electronic device, input including a rating of the reduced profile information, adjusting the reduced profile information according to the input, and updating the display with the adjusted, reduced profile information.

Throughout the following description, specific details are set forth in order to provide a more thorough understanding to persons skilled in the art. However, well-known elements may not be shown or described in detail to avoid unnecessarily obscuring of the disclosure. Accordingly, the description and drawings are to be regarded in an illustrative, rather than a restrictive, sense.

This disclosure relates generally to matching electronic data records and particularly to methods and systems for matching profile records in an online social network.

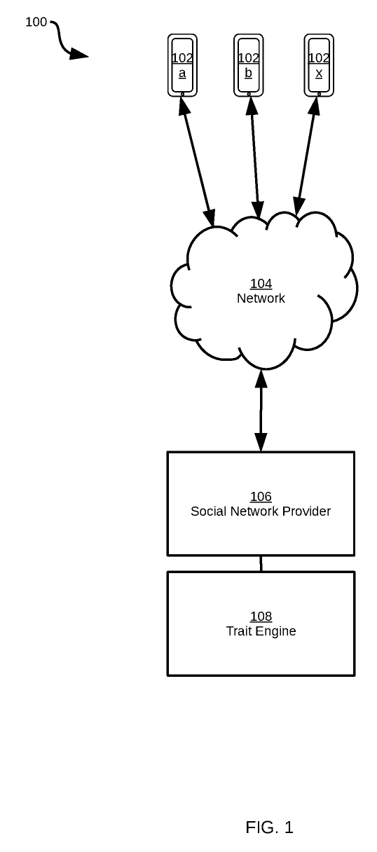

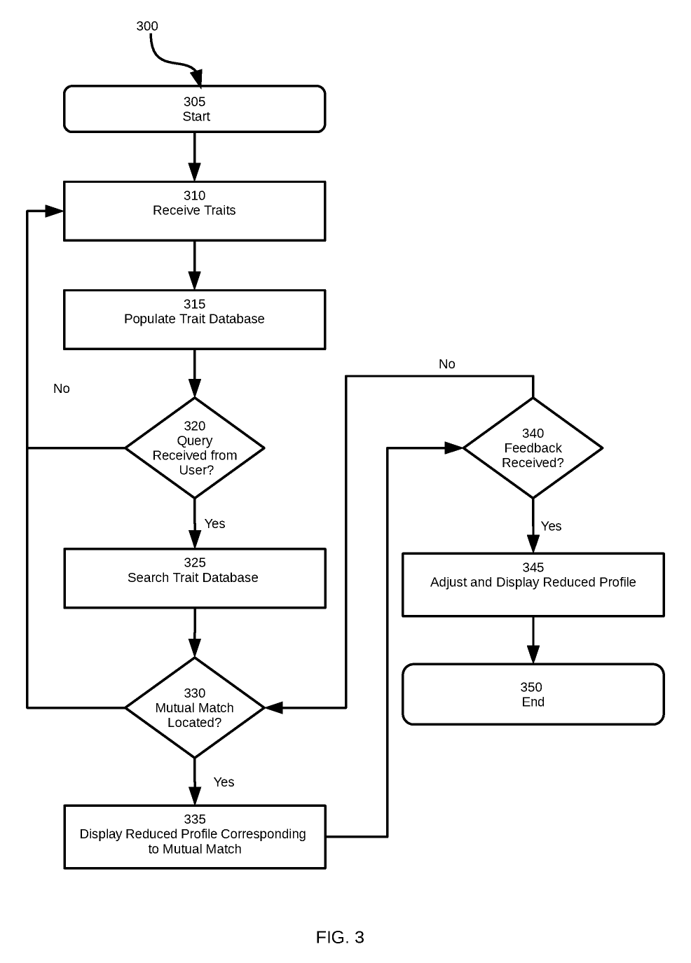

The following description provides, with reference to FIG. 1, detailed descriptions of exemplary systems for matching profile records. Detailed descriptions of corresponding methods are provided in connection with FIG. 3.

A block diagram of an example of a system 100 for matching profile records is shown in FIG. 1. According to this example, the system 100 includes one or more electronic devices 102-a, 102-b, . . . , 102-x (generically referred to herein as “electronic device 102” and collectively as “electronic devices 102”), all of which are connected to a social network provider via a network 104 such as the Internet.

Typically, the electronic devices 102 are associated with users who provide input for response from the social network provider (server) 106. For example, the users can be participants in an online dating or other social networking system.

Each electronic device 102 can be any of a desktop computer, smart phone, laptop computer, tablet computer, smart watch or other wearable device, and the like. The electronic device 102 can include one or more processors, a memory, input and output devices (typically including a display, a speaker, a microphone, a camera, and other sensors), and a network interface device as described below in connection with the server 106.

The electronic device 102 can exchange messages with the social network provider (server) 106 via the network 104 using a client application (not shown in FIG. 1) loaded on the electronic device 102. In one example, the client application can be a mobile application downloadable from an application marketplace that exchanges messages with the server 106.

Generally speaking, the social network provider 106 can be any entity that provides social networking services, communication services, dating services, and so forth. For example, the social network provider 106 can host a website or mobile application that allows two or more users, such as the users at the electronic devices 102, to communicate with one another via the website or mobile application.

The server 106 is typically a server or mainframe within a housing containing an arrangement of one or more processors, volatile memory (i.e., random access memory or RAM), persistent memory (e.g., hard disk or solid state devices), and a network interface device (to allow the server 106 to communicate over the network 104) interconnected by a bus. Many computing environments implementing the server 106 or components thereof are within the scope of the present specification. The server 106 can include a pair (or more) of servers for redundancy or load-balancing purposes, connected via the network 104 (e.g., an intranet or across the Internet) (not shown). The server 106 can be connected to other computing infrastructure including displays, printers, data warehouse or file servers, and the like. The server 106 can include a keyboard, mouse, touch-sensitive display (or other input devices), a monitor (or display, such as a touch-sensitive display, or other output devices) (not shown in FIG. 1).

The server 106 includes a network interface device interconnected with the processor that allows the server 106 to communicate with other computing devices such as the electronic devices 102 via a link with the network 104, or via a direct, local connection. The network 104 can include any suitable combination of wired and/or wireless networks, including but not limited to a Wide Area Network (WAN) such as the Internet, a Local Area Network (LAN), HSPA/EVDO/LTE cell phone networks, WiFi networks, and the like.

The network interface device is selected for compatibility with the network 104, as well as with local links as desired. In one example, the link between the network interface device and the network is a wired link, such as an Ethernet link. The network interface device thus includes the necessary hardware for communicating over such a link. In other examples, the link between the server 106 and the network 104 can be wireless, and the network interface device can include (in addition to, or instead of, any wired-link hardware) one or more transmitter/receiver assemblies, or radios, and associated circuitry.

The server 106 stores, in the memory, a plurality of computer readable instructions executable by the processor. These instructions can include an operating system and a variety of applications. Among the applications in the memory is an application (not shown in FIG. 1). When the processor executes the instructions of the application, the processor is configured to perform various functions specified by the computer readable instructions of the application, as will be discussed below in greater detail.

The system 100 typically includes additional servers, such as a trait engine 108 shown in FIG. 1, each of which can be configured like the server 106, for carrying out specific functions of the system 100 described further herein. Multiple server instances can be created depending on the load of the server 106. According to one example, all functions of these servers can be performed by modules of a single server, if desired. In one example, the function of the server 106 can be performed by the electronic device 102.

The system 100 can include a user profile database 202. The user profile database 202 maintains one or more electronic records representing users and their subject trait parameters and desired trait parameters. The user profile database 202 can be a database application loaded on the server 106, a stand-alone database server or a virtual machine in communication with the network interface device of the server 106, or any other suitable database.

In operation, a user can use the client application loaded on the electronic device 102 to exchange messages with the server 106. The server 106 can authenticate the electronic device 102-1 or its user by querying the user profile database 202.

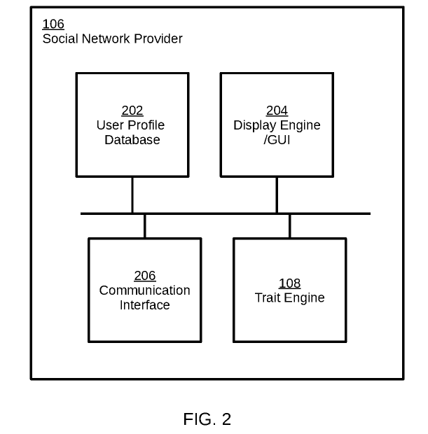

Referring now to FIG. 2, a diagram of a social network provider, such as the social network provider 106 discussed in FIG. 1, is shown. A user profile database 202 is provided for storing data associated with each of the users, such as each user associated with the electronic device 102. A user profile can include privacy settings, provide contact information, as well as subject trait parameters or desired trait parameters. When the user adds additional information to the user profile, such as adding additional trait parameters, the user profile in the user profile database 202 can be updated with the information added. The user profile can be stored, modified, added, and so forth to any storage medium.

A display engine/GUI 204 can also be provided by the social network provider 106. The display engine/GUI 204 displays user profile information, trait parameters, and so forth to the users. The users can interact with the social network provider 106 via the display engine/GUI 204. For example, the users can access their own user profile and trait parameters, access other users' information available via the social network provider, and so forth via the display engine/GUI 204.

A communications interface 206 is provided for communicating with the users, such as via the electronic device 102 described herein, over the network 104. The electronic device 102 communicates various types of information to the social network provider 106 via the communications interface 206.

A trait engine 108 tracks one or more trait parameters associated with the users. In one example, the trait engine can be a stand-alone server. The trait engine 108 can provide the matching of trait parameters and communicate with the user profile database 202 to update contact lists with matches.

Although the social network provider 106 is described as being comprised of various components (the user profile database 202, the display engine/GUI 204, the communications interface 206, and the trait engine 108), fewer or more components can comprise the social network provider 106 and still fall within the scope of various examples disclosed in the present specification.

Examples according to the present specification address the complexities of building human relationships using an online social network. A single mother of a child with disabilities can benefit from connecting with other parents facing similar challenges. In her career, that woman can also be seeking an investor whom she can pitch ideas to over a game of squash. And like most modern people she wants a robust love life without going out every weekend and sorting through endless online databases in her free time.

Current solutions for searching for such relationships can be difficult to use. Searching for a plumber on Craigslist is quite a different task from locating a travel companion who loves Japan, and hates sushi as much as the user in question. Unless that sushi-hating Japanophile searches for the user on that very same forum at the exact same time, the odds of making a connection are low.

According to one example, each user profile data record includes subject trait parameters (e.g., possessed by the user) as well as desired trait parameters (e.g. traits desired in a match). The trait parameters can be maintained in a user's profile record maintained by the user profile database 202.

Techniques disclosed in the present specification uncover matches representing other users who are specifically searching for compatible desired and possessed matches.

According to disclosed examples of the present specification, upon determining a match, the system can forward an automated introduction to the electronic devices 102. In one example, the introduction message can be an email that contains pertinent information selected from the prospective user's profile record: first name, profile picture, and a number of complementary traits.

Users can be encouraged to interface by incrementally revealing their traits to each other, until they decide to connect directly. This interaction can be accelerated by being entirely click-based.

If a matched prospect reveals a list of favorite movies to another user, that list can be automatically disclosed.

In one example of the present specification, the database of subject trait parameters cannot be accessed directly, enhancing the privacy and security of the system. Such privacy measures can promote honest and robust profiles. This allows users to include very personal and intimate traits, which they might otherwise be embarrassed or afraid to include in a public online profile.

In one example, trait parameters can be binary (e.g. “must have” or “must not have”) to rule out undesirable candidate suggestions. For example, “must have graduated from an Ivy League school” filters-out undesirable candidates in the same way “must not be married” does. A user does not necessarily need to possess any of the traits they are looking for in someone—whom a user is looking for is entirely up to them.

The system can include optional modules including a loyalty system in which users accumulate points for each trait added to a profile and for every interaction with a match. Points can be redeemed for new searches: Each Must have, Must not have, and each Premium Mailbox Feature costs points. Points can also be redeemed for targeted real-life discount offers from participating advertisers. A Freemium model creates external incentives to increase match-result interaction, network promotion and profile building. As well, introduction messages can contain an incentive to redeem points for value at local venues or events that correspond with users' interests (e.g., spend points for 2-for-1 rock climbing pass, if “rock climbing” is included in the user's searches or mutual interests). Sponsors or advertisers can receive double the redemption rate per each targeted offer if both the matched user and the searching user engage in the offer. Additional points can be purchased to expedite features or create extra searches.

Advantageously, employing the disclosed techniques, users benefit from social networking without over-sharing and social media fatigue. Investors profit from unprecedented specific long term user analytics. Moreover, users never experience matches or mutual matches in terms of quantity. Therefore, the network's growth is not inhibited by the hesitation of early adopters. The experience of Pinterest is the closest analog to the user experience: Adding traits to new and existing searches feels like “pinning” a desired item.

A flowchart illustrating an example of a disclosed method of profile matching is shown in FIG. 3. This method can be carried out by the applications or other software executed by, for example, the processor of the server 106. The method can contain additional or fewer processes than shown and/or described, and can be performed in a different order. Computer-readable code executable by at least one processor of the server 106 to perform the method can be stored in a computer-readable storage medium, such as a non-transitory computer-readable medium.

With reference to FIG. 3, a method 300 starts at 305 and, at 310, the server 106 receives one or more trait parameters including subject trait parameters (describing the users) and desired trait parameters (describing the user's desired match). At 315, the trait parameters and associated user profiles records are populated in a database maintained by the server 106 and/or the trait engine 108. At 320, a query is received from a user associated with an electronic device 102. The database is searched at 325 and if a mutual match is located, at 330, the match is shown in an email, SMS, or as a system notification on a display of the electronic device 102 at 335. Notifications can be adjusted for all possible variations of experience, such as wearable devices. These include: audio prompts, kinesthetic notifications, and other types of communications.

In this example, only a reduced profile is shown. At 340, feedback is received (e.g. rating) which can adjust the display of the reduced profile (e.g. to show more information) at 345 if, for example, the feedback is positive. If a certain percentage of the desired traits are met on both profiles, each user can be prompted by a system notification to disclose or add more profile information in anticipation of a match. At 350 the method ends. If a match is not located at 330, the method continues to receive trait parameters and queries from users.

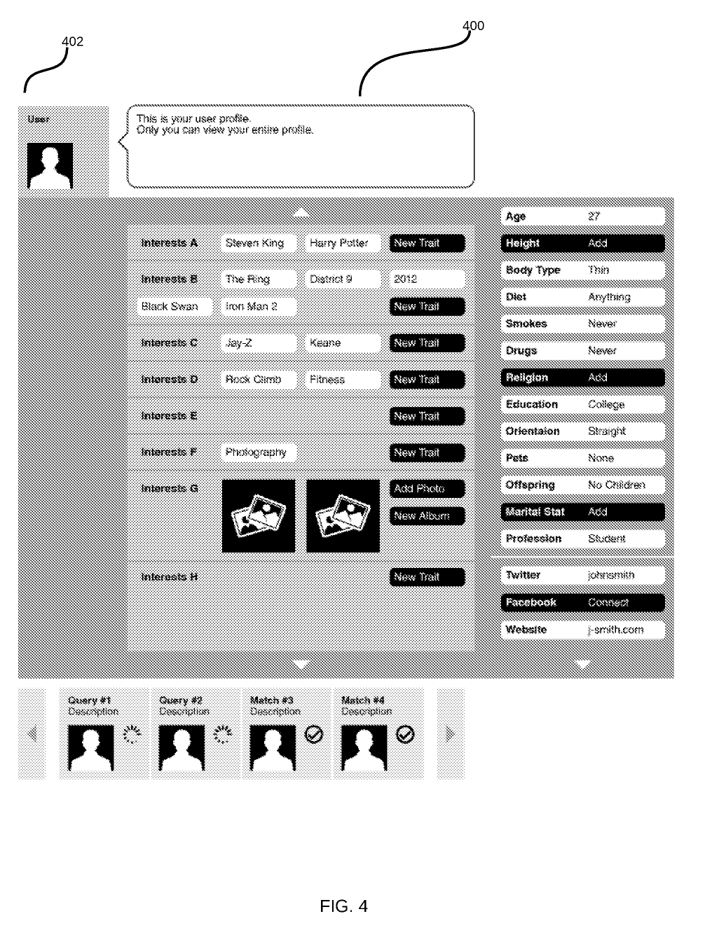

Examples of screenshots on the display of the electronic device 102 when loaded with an application to operate in accordance with the present disclosure are depicted in FIG. 4 through FIG. 6 and described with continued reference to FIG. 3.

With reference to FIG. 4, screenshot 400 may be launched by opening a client application on the electronic device 102. A listing of user profile record information is shown at 402 including trait information at 404 (fields) and 408 (categories). Other data fields may be displayed according to the content of the user profile record. The listing may be filtered.

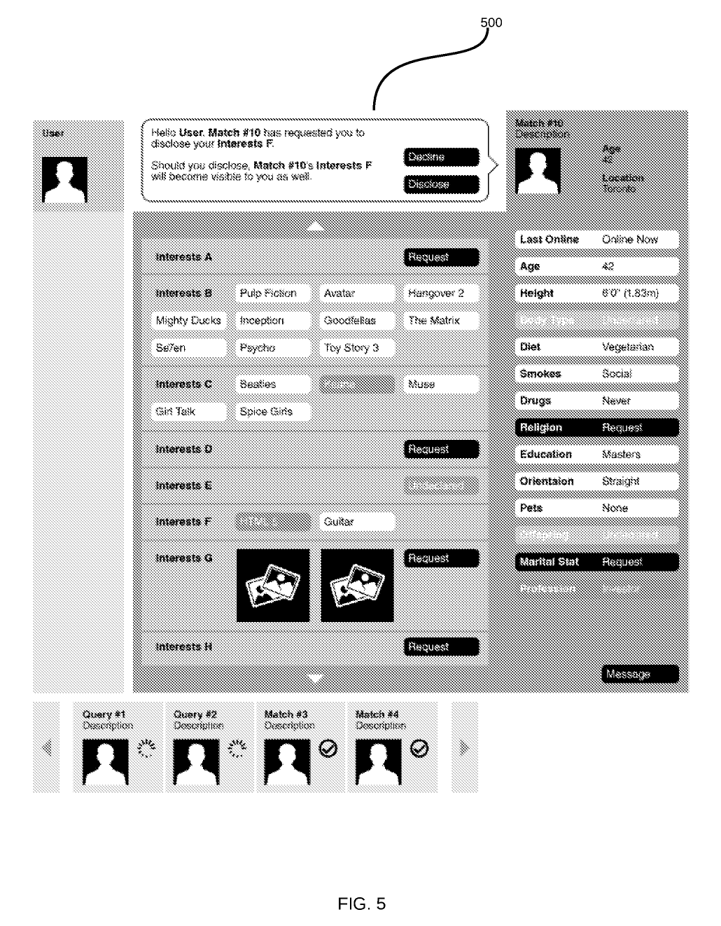

Turning to FIG. 5, screenshot 500 can be launched by tapping or otherwise selecting one of the matches in FIG. 4. Reduced profile information for the match is shown at 506, and additional information can be shown through the interface button 504 (or declined at 502).

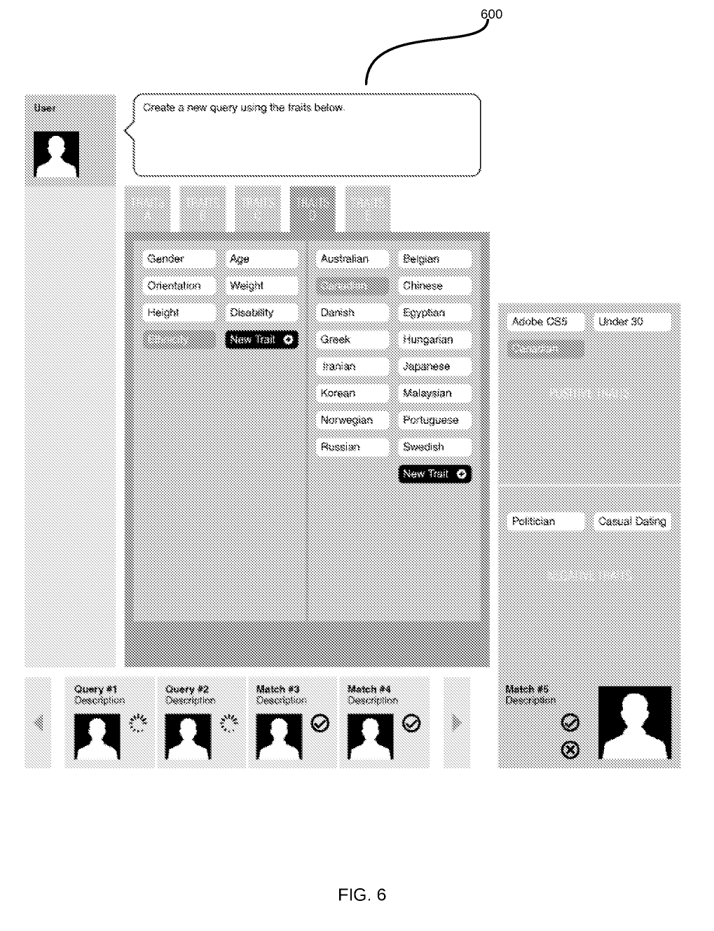

Now with reference to FIG. 6, screenshot 600 is launched by tapping or otherwise selecting the user's own profile. A complete list of subject trait parameters and desired trait parameters is shown.

A method in a server having a processor, a memory, and a network interface device includes the steps of maintaining, in the memory, a plurality of user profile records, each user profile record comprising an identifier, one or more subject trait parameters, and one or more desired trait parameters, receiving a query comprising a user profile record identifier associated with a first electronic device, determining a mutual match by searching the plurality of user profile records using the query to locate a matched user profile record identifier associated with a second electronic device, populating, on a display of the first electronic device, reduced profile information corresponding to the matched user profile record identifier, receiving, from the first electronic device, input comprising a rating of the reduced profile information, adjusting the reduced profile information according to the input, and updating the display with the adjusted, reduced profile information.

The determining step includes determining at least one of the subject trait parameters of a prospective user profile record is compatible with at least one of the desired trait parameters of the user profile record under query, and determining at least one of the subject trait parameters of the user profile record under query is compatible with at least one of the desired trait parameters of the prospective user profile record.

The determining step can include determining a mutual match for each of the one or more desired trait parameters of the user profile record under query and the one or more desired trait parameters of the prospective user profile record.

The plurality of desired trait parameters can be constrained in number to improve the likelihood of matching. For example, the one or more desired trait parameters can be constrained in number to three.

The desired trait parameters and the subject trait parameters for a given user profile record can be mutually exclusive.

The method of claim 1 can further include the steps of populating, on a display of the second electronic device, second reduced profile information corresponding to the user profile record identifier under query; receiving, from the second electronic device, input comprising a rating of the second reduced profile information; adjusting the second reduced profile information according to the input; and updating the display with the adjusted, second reduced profile information.

The adjusting can include increasing the information if the rating is a positive rating.

Each electronic device can be a desktop computer, a smart phone, a laptop computer, a tablet computer, or a wearable device.

A system includes a server having a processor and connected to a network interface device and a memory, wherein the processor is configured to maintain, in the memory, a plurality of user profile records, each user profile record comprising an identifier, one or more subject trait parameters, and one or more desired trait parameters receive a query comprising a user profile record identifier associated with a first electronic device, determine a mutual match by searching the plurality of user profile records using the query to locate a matched user profile record identifier associated with a second electronic device, populate, on a display of the first electronic device, reduced profile information corresponding to the matched user profile record identifier, receive, from the first electronic device, input comprising a rating of the reduced profile information, adjust the reduced profile information according to the input, and update the display with the adjusted, reduced profile information.

While a number of exemplary aspects and examples have been discussed above, those of skill in the art will recognize certain modifications, permutations, additions and sub-combinations thereof.

1. A method in a server having a processor, a memory, and a network interface device, the method comprising the steps of:
maintaining, in the memory, a plurality of user profile records, each user profile record comprising an identifier, one or more subject trait parameters, and one or more desired trait parameters;
receiving a query comprising a user profile record identifier associated with a first electronic device;
determining a mutual match by searching the plurality of user profile records using the query to locate a matched user profile record identifier associated with a second electronic device;
populating, on a display of the first electronic device, reduced profile information corresponding to the matched user profile record identifier;
receiving, from the first electronic device, input comprising a rating of the reduced profile information;
adjusting the reduced profile information according to the input; and
updating the display with the adjusted, reduced profile information.

2. The method of claim 1 further wherein the determining step comprises:
determining at least one of the subject trait parameters of a prospective user profile record is compatible with at least one of the desired trait parameters of the user profile record under query; and
determining at least one of the subject trait parameters of the user profile record under query is compatible with at least one of the desired trait parameters of the prospective user profile record.

3. The method of claim 2 wherein the determining step comprises determining a mutual match for each of the one or more desired trait parameters of the user profile record under query and the one or more desired trait parameters of the prospective user profile record.

4. The method of claim 3 wherein the one more desired trait parameters is constrained in number to improve a likelihood of matching.

5. The method of claim 4 wherein the one or more desired trait parameters is constrained in number to three.

6. The method of claim 5 wherein the desired trait parameters and the subject trait parameters for a given user profile record are mutually exclusive.

7. The method of claim 1 further comprising:
populating, on a display of the second electronic device, second reduced profile information corresponding to the user profile record identifier under query;
receiving, from the second electronic device, input comprising a rating of the second reduced profile information;
adjusting the second reduced profile information according to the input; and
updating the display with the adjusted, second reduced profile information.

8. The method of claim 7 wherein the adjusting comprises increasing information if the rating is a positive rating.

9. The method of claim 1 wherein the first electronic device is selected from one of: a desktop computer, a smart phone, a laptop computer, a tablet computer, and a wearable device.

10. A system comprising:
a server having a processor and connected to a network interface device and a memory, wherein the processor is configured to:
maintain, in the memory, a plurality of user profile records, each user profile record comprising an identifier, one or more subject trait parameters, and one or more desired trait parameters;
receive a query comprising a user profile record identifier associated with a first electronic device;
determine a mutual match by searching the plurality of user profile records using the query to locate a matched user profile record identifier associated with a second electronic device;
populate, on a display of the first electronic device, reduced profile information corresponding to the matched user profile record identifier;
receive, from the first electronic device, input comprising a rating of the reduced profile information;
adjust the reduced profile information according to the input; and
update the display with the adjusted, reduced profile information.

11. The system of claim 10 wherein the electronic device is selected from one of: a desktop computer, a smart phone, a laptop computer, a tablet computer, and a wearable device.
